(19) United States
(12) Patent Application Publication
(10) Pub. No.: US 2016/0307167 A1
(43) Pub. Date: Oct. 20, 2016

(54) MANAGING POTENTIAL MEETING CONFLICTS

(71) Applicant: International Business Machines Corporation, Armonk, NY (US)

(72) Inventor: Mayank B. Bathiya, Jamnagar (IN)

(21) Appl. No.: 15/067,236

(22) Filed: Mar. 11, 2016

Related U.S. Application Data
(63) Continuation of application No. 14/686,902, filed on Apr. 15, 2015.

(51) Int. Cl. G06Q 10/10; G06Q 10/06; G06Q 10/02

(52) U.S. Cl. CPC G06Q 10/1095; G06Q 10/02; G06Q 10/06314

(57) ABSTRACT

Management of potential meeting conflicts is provided to allow extending a meeting beyond the original booking period of a room, or other resource, as well as automatically coordinate and/or adjust the resource bookings of affected meetings with the owner's consent of the affected meetings. The coordination satisfies the criteria set by a meeting owner for the affected meeting and/or global criteria defined at the organization level. Any change in the resource as part of the coordination and/or adjustment is communicated to the affected participants and/or resource manager via a specified communication channel, such as an instant message.

### BACKGROUND OF THE INVENTION

The present invention relates generally to the field of conference resources management, and more particularly to management of meeting conflicts.

Planning, organizing and conducting a conference can be challenging. For the smooth running of a conference, co-operation and participation of many individuals are needed so that the important aspects of the conference are covered. Such aspects include: the chairperson, or owner, participants, technical infrastructure, audio-visual facilities, projectors and communication equipment (phones, speakers and microphones).

Conference rooms and other resources associated with meetings and conferences have peak periods of high demand, quiet periods of low demand, and shoulder periods of variable demand. Accordingly, the arrangement of various conferences and/or meetings needs to be carefully coordinated, especially, for a conference taking place during a peak period.

The terms “conference” and “meeting” are used interchangeably herein. While the term “conference” may suggest a conference call and the term “meeting” may suggest a live gathering, as used herein, the terms refer to any meeting of persons, whether by phone, internet, video, in-person, or otherwise. The term “resource” refers to anything necessary, or desired, to facilitate the meeting, such as a conference room, telephone, call-in number, video equipment, and presentation equipment.

### SUMMARY

In one aspect of the present invention, a method, a computer program product, and a system includes: determining a first consent level for a first meeting; determining a first meeting resource criteria; identifying a first set of meeting resources that meet the first meeting resource criteria; reserving a first meeting resource from the first set of meeting resources; and responsive to a change in the first meeting resource criteria, reserving a second meeting resource.

### BRIEF DESCRIPTION OF THE SEVERAL VIEWS OF THE DRAWINGS

FIG. 1 is a schematic view of a first embodiment of a system according to the present invention;

FIG. 2 is a flowchart showing a method performed, at least in part, by the first embodiment system; and

FIG. 3 is a schematic view of a machine logic (for example, software) portion of the first embodiment system.

### DETAILED DESCRIPTION

Management of potential meeting conflicts is provided to allow extending a meeting beyond the original booking period of a room, or other resource, as well as automatically coordinate and/or adjust the resource bookings of affected meetings with the owner's consent of the affected meetings. The coordination satisfies the criteria set by a meeting owner for the affected meeting. Any change in the resource as part of the coordination and/or adjustment is communicated to the affected participants and/or resource manager via a specified communication channel, such as an instant message. The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium, or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network, and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture, including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions, or acts, or carry out combinations of special purpose hardware and computer instructions.

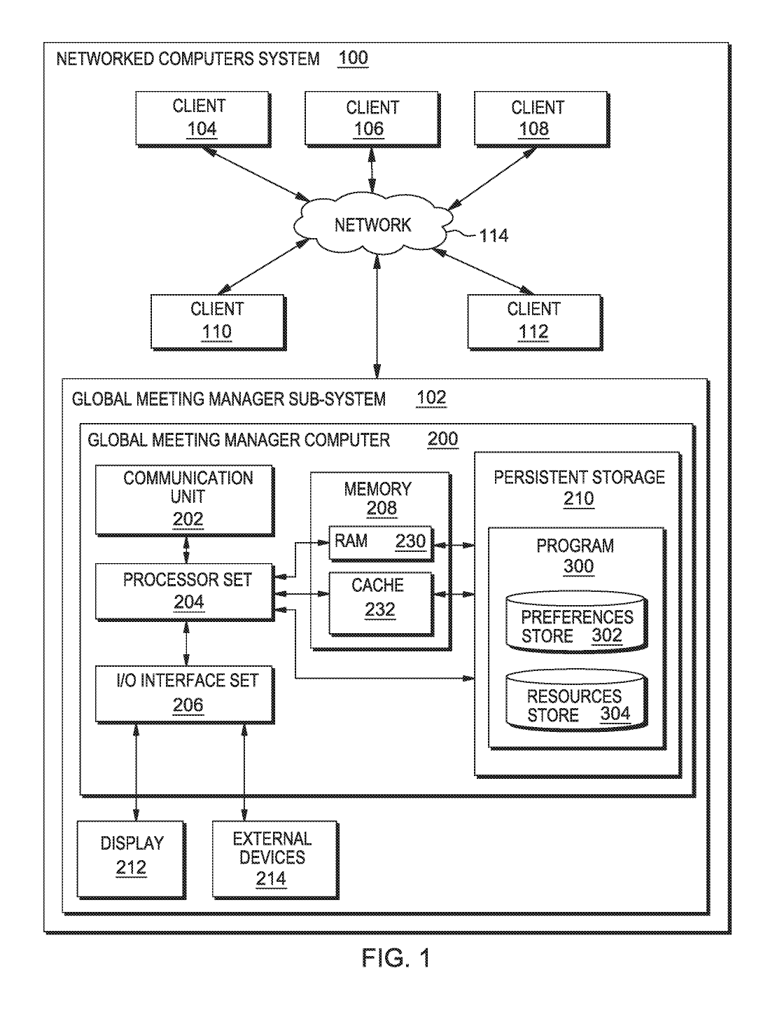

The present invention will now be described in detail with reference to the Figures. FIG. 1 is a functional block diagram illustrating various portions of networked computers system 100, in accordance with one embodiment of the present invention, including: server sub-system 102; client sub-systems 104, 106, 108, 110, 112; communication network 114; server computer 200; communication unit 202; processor set 204; input/output (I/O) interface set 206; memory device 208; persistent storage device 210; display device 212; external device set 214; random access memory (RAM) devices 230; cache memory device 232; preferences store 302; resource store 304; and program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail below.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware component within a system. For example, the communications fabric can be implemented, at least in part, with one or more buses.

Memory 208 and persistent storage 210 are computer readable storage media. In general, memory 208 can include any suitable volatile or non-volatile computer readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions, and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either, or both, physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer readable storage media such as, for example, thumb drives, portable optical or magnetic disks, and memory cards. Software and data used to practice embodiments of the present invention, for example, program 300, can be stored on such portable computer readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the present invention. However, it should be appreciated that any particular program nomenclature herein is used merely for convenience, and thus the present invention should not be limited to use solely in any specific application identified and/or implied by such nomenclature.

Program 300 operates to manage the uncertainties of meetings including extending a meeting beyond the original booking period of a resource and adjusting the resource bookings of an affected meeting. Program 300 ensures any such adjustment is done with the consent of the meeting owner of the affected meeting, and satisfies the criteria set by the meeting owner for the affected meeting (e.g., participant's capacity and resource availability). Further, any such change in the resource as part of the adjustment is communicated to the affected participants via an instant message or other communication channel, which may be pre-specified by the meeting owner, corporate policy, etc.

Some embodiments of the present invention recognize the following facts, potential problems and/or potential areas for improvement with respect to the current state of the art: (i) a conflict management solution is needed for extending a meeting period; (ii) meeting conflicts often require compromises between the teams who wish to hold a meeting; (iii) the prior and/or real-time consent of the meeting stakeholders is needed for resolving meeting conflicts automatically; and/or (iv) meeting conflict management should keep manual interaction to a minimum.

During a typical meeting, participants occasionally experience the need to extend the use of a resource, for example, a conference call number or meeting room, beyond the booked period. Also, while going to the meeting room, occasionally the team who has previously booked the room is still using it due to some unplanned urgency. If someone has a subsequent room booking, compromises and/or adjustments are often made at the personal level between the teams, for example, compromise may include asking the other team to wait for a few more minutes while the current meeting is wrapped up quickly, which is a lose-lose situation for both the teams. In addition, adjustments by asking the other team to settle in some other room can also be made. Today, these types of adjustments are done at a personal level and happen only at the last moment when the other team is at the door, or otherwise waiting for access to the booked resource.

Usually, near the end of a scheduled meeting (e.g., before 5 minutes) that the meeting may need to be extended for a few more minutes. Conventionally, in that 5 minutes, to make a seamless adjustment before the last moment when the other team is actually at the door, possible actions include: (i) find the next meeting owner/chairperson and the list of the participants with the subsequent room booking; (ii) find their booking period for this room; (iii) find a nearby available room with a similar capacity and resources for their booking period; (iv) book that room for the entire period of their booking period; and (v) send a notification email to all the participants to directly approach to the new room or better option is to send an instant message to all of them individually.

It is not practical in 5 minutes to manually make the above five step seamlessly happen. Thus, as mentioned, in most of the cases, a compromise is agreed upon by asking the other team to wait for a while as the ongoing call is quickly finished. Or, in a few cases, a new room is booked and to the next team adjusts to the alternative resource while they are, for example, at the meeting room door.

Some embodiments of the present invention provide a method to automatically coordinate/adjust the rooms/resources between the conflicting teams in compliance with the criteria originally set by all the affected stakeholders. As per the initial planning, there is no conflict between the teams. However, with the last minute change in the plan of one team, conflict occurs. Such unplanned meeting conflicts between two teams needs to be resolved with minimum user interaction to create a win-win situation for both the teams.

To organize a meeting, a meeting owner/attendees have some specific requirements for the room and/or other resources. In most of the cases, as long as the room and/or other resource requirements are met, these stakeholders don't care which resource is booked. For example, in a scenario where a first team keeps a second team waiting for 5 minutes before vacating the meeting room on time, there are many other rooms available, but the second team has to find that out and book it before the second team can use it. In such case either the first team should confirm before the few minutes that they vacate the room on time or they should pre arrange an alternative room for the second team based on the second team's requirements with prior/on time consent of both the stakeholders. As long as the requirements are met, the second team can go seamlessly with their meeting in the alternative room. The proposed method herein can extending the meeting for the first team and take care of all these conflict management options.

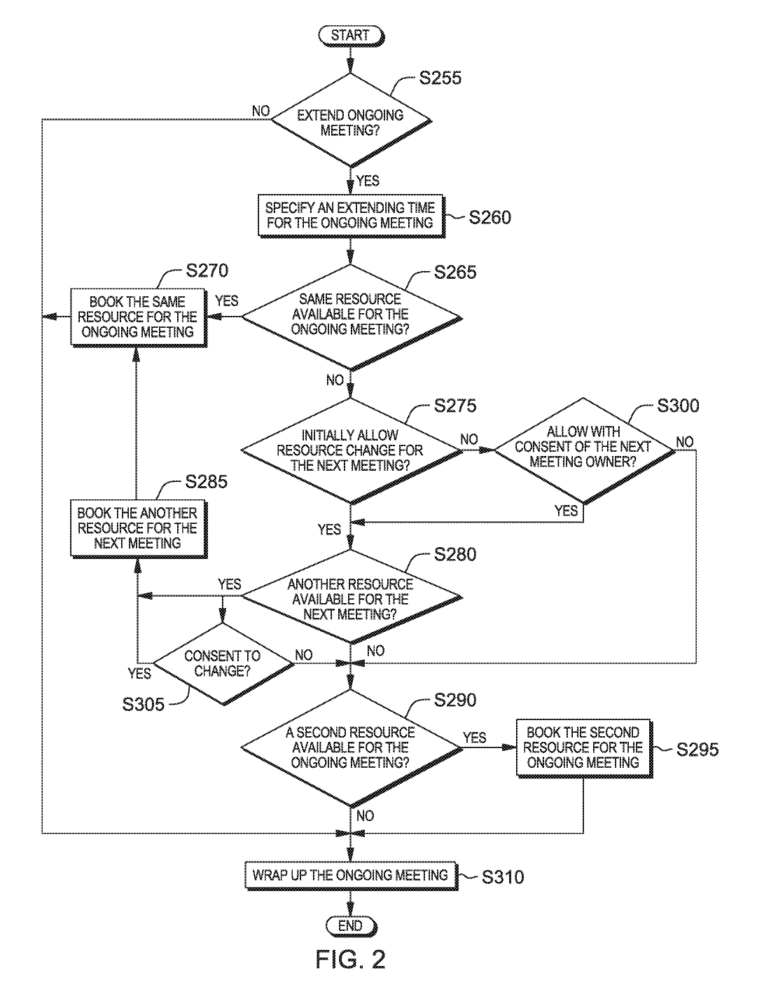

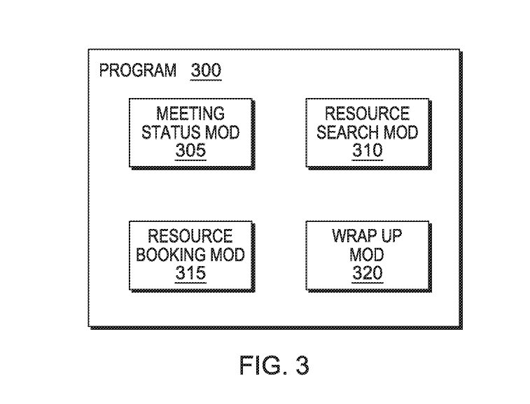

FIG. 2 shows flowchart 250 depicting a first method according to the present invention. FIG. 3 shows program 300 for performing at least some of the method steps of flowchart 250. This method and associated software will now be discussed, over the course of the following paragraphs, with extensive reference to FIG. 2 (for the method step blocks) and FIG. 3 (for the software blocks).

Processing proceeds to step S255 once program 300 begins from START, where meeting status module “mod” 305 prompts a message to ask the owner of the ongoing meeting whether to extend the ongoing meeting beyond the scheduled period of time. In this exemplary embodiment, for any meeting, at a pre-determined time (e.g., 5 minutes, which is configurable) prior to the scheduled end of the meeting, the meeting status mod prompts a message to the meeting owner—for example, the ongoing meeting is scheduled to end in the next 5 minutes, and do you want to extend this meeting? The meeting owner chooses either to not extend the ongoing meeting (e.g., clicking on a cancel button on the prompted message) or extend the ongoing meeting (e.g., clicking on a yes button on the prompted message). If the owner chooses to not extend the ongoing meeting, processing proceeds to step S310 where wrap-up module 320 wraps up the ongoing meeting prior to or at the end of originally scheduled time. The next meeting that books the same room can go ahead to use this same room without conflicts. If the owner chooses to extend the ongoing meeting beyond the originally booked period of time, a chain of subsequent meetings that book for this same room might be affected.

If “No” is chosen from step S255 by the owner of ongoing meeting, processing proceeds to step S310 where wrap-up module 320 wraps up the ongoing meeting. The next meeting that books the same room can go ahead to use this same room without conflicts.

If “Yes” is chosen from step S255 by the owner of ongoing meeting, processing proceeds to step S260, where meeting status module 305 asks the ongoing meeting owner to specify a period of time for the ongoing meeting beyond the originally scheduled time. In this exemplary embodiment, the meeting owner is asked to input a time in a user input field on a prompted message box where a default value is prefilled. For example, the owner requests to extend the ongoing meeting for 15 more minutes. Alternatively, the meeting owner is prompted to fill in a text field stating the specific extension time desired. Alternatively, only 15 minute extensions are provided, which may be repeatedly prompted for and requested as the meeting proceeds over the originally booked time.

Processing proceeds to step S265, where resource search module 310 search the resource booking system to find out whether the same room originally booked for the ongoing meeting is still available for the specified extending time for the ongoing meeting. In this example, the resource booking system includes meeting resources stored in resource store 304 and meeting resource preferences stored in preferences store 302. At the same moment, when the ongoing meeting owner clicks on the “Extend Meeting” button on the prompted message after specifying the extending 15 minutes, module 310 starts searching the resource booking system to determine whether or not the same resource is available for the specified 15 minutes for the ongoing meeting.

If “Yes” branch is selected from step S265, processing proceeds to step S270, where resource booking module 315 books the same resource for the ongoing meeting for the specified extending period of time. In this example, upon finding the same room is available, module 315 books this room for 15 more minutes for the ongoing meeting. The calendars of the participants of the ongoing meeting get booked for 15 more minutes for all the participants who have originally accepted the meeting request. Once the booked extending time passes, processing proceeds to step S310 where wrap-up module 320 wraps up the ongoing meeting. Alternatively, processing returns to step S255 after a meeting extension is granted. The next meeting that books the same room can go ahead to use this same room without conflicts. Alternatively, if the owner of the ongoing meeting desires to extend the meeting more than one time, and also no subsequent meetings are booked during the multiple extending period of time, then the meeting owner of the ongoing meeting is allowed to do that.

If “NO” branch is selected from step S265, processing proceeds to step S275, where meeting status module 305 presents a message asking the owner of the next meeting whether to find another resource for the next meeting. In this exemplary embodiment, if the same resource is not available for the ongoing meeting for the specified extending period of time, then that indicates the same resource is already booked for a subsequent meeting.

At the time of initiating a meeting request, the meeting chairperson registers a prior consent to allow the booking system to take resource change/booking decisions on his behalf (i.e., without his intervention); and set the resource requirement criteria for the booking system to take the booking decisions at a later point (instead of relying on the exact resource booking at the time of meeting). In case of any last moment change in the plan of another meeting, the booking system automatically takes resource adjustment decisions based on: (i) prior consent of the stakeholder(s); (ii) room and other resource requirement criteria set by the meeting chair persons; and/or (iii) any other criteria set at the organization level. Those criteria can be set at an organization level (also refereed herein to as a global level), for example, a flag called “Allow System to Change the Meeting Room” can be used at an organization level.

The term “resource” herein refer to any resource needed for a meeting including a phone line, an office or conference room, a projector for computers or transparencies, and so forth. The consent of a meeting owner herein also refers to as “a consent level” to indicate how much, or to what degree, a meeting owner will allow the meeting manager/booking system to reserve alternative resources. For example, a meeting owner may consent to moving a meeting to another building in the interest of letting another team have access to the meeting room in his building. There may be other consent levels where the meeting owner will only allow an alternative conference call-in number be assigned.

In one embodiment, the flag at the global level is defaulted as “On”, which means the booking system has prior consent of the meeting owner and is allowed to change the meeting resource for this meeting. In addition, the booking system (e.g., program 300 in FIG. 1) ensures that the new resource qualifies the criteria that meeting owner originally set. Resource criteria may include: location, capacity, availability of a projector, and/or availability of other resources.

In another embodiment, the flag at the global level is defaulted as “Off,” which means the booking system is not allowed to change the meeting resource for this meeting.

In yet another embodiment, the global flag is defaulted as “Requires Approval”, which means the booking system proposes a change of the room to the meeting owner via a pre-determined communication channel, for example, a dialog box in a web browser. Changes to the meeting resource are made only if the meeting owner approves the change.

In some embodiments of the present invention, the administrator has an access to such global level flag. This flag decides the default behavior of each meeting at an organization level. Alternatively, a similar flag is available at the meeting level and the meeting owner is able to override the default value set at an organization level for each meeting.

In yet another embodiment, the booking system gives preference to an executive in the organization. For example, an executive attending an ongoing meeting decides to extend the ongoing meeting. In such scenario, consent of the affected team may not even matter, and the booking system always relocates the affected meeting, even if it does not find a meeting room that qualifies all the criteria. (e.g., it may relocate the affected meeting to another floor/with lesser capacity etc.)

Alternatively, the criteria value is flexible at the time when the booking system takes the resource changing decision, even though the initial criteria are fixed. For example, team A with 6 persons books meeting room A with a capacity of 6 persons. Team B with 6 persons books meeting room B (for a same period of time as the team A) with a capacity of 4 persons as meeting room B is the only one available at that time. When the meeting time approaches, 1 person from team A declines the meeting, and another 2 persons choose to attend via telephone from home. So, in team A, only 3 persons are in the meeting room with the capacity of 6 whereas all the 6 members of team B have to adjust in the room of capacity 4. In such case, if both of the teams set the room/resource requirement criteria and leave it to the booking system to decide on the room booking near to the meeting start time, the booking system automatically assigns the room with a capacity of 4 to team A and the room with a capacity of 6 to team B.

In this exemplary embodiment, if the flag at the global level is “On”, that is, a “Yes” is chosen in step 275, then processing proceeds to step S280 where resource search module 310 searches to find a resource available for the next meeting. With the prior consent of the next meeting owner, module 310 tries to find a resource considering the criteria requirements set by the next meeting owner. Criteria includes: (i) room capacity; (ii) projector availability; (iii) internet access; and/or (iv) speaker phone.

If an available resource is found for the next meeting, processing proceeds to step S285, where resource booking module 315 books the available resource for the next meeting for the initially specified period of meeting duration. In this example, upon finding a room is available, the booking system books that room and informs the participants of the next meeting about change in the room by, for example, prompting a message on their systems, or sending an email, or using an instant messenger service. In addition, if the digital notice boards are installed outside the meeting rooms and are connected with the booking system, the boards show a message indicating a change in the meeting room for the next meeting. After the available resource is booked for the next meeting, processing proceeds back to step S270 where module 315 books the resource in which the ongoing meeting is for 15 more minutes for the ongoing meeting. Calendar of the participants of the ongoing meeting get booked for 15 more minutes for all the participants who have originally accepted the meeting request. Once the booked extending time passes, processing proceeds to step S310 where wrap-up module 320 wraps up the ongoing meeting. Alternatively, if the owner of the ongoing meeting desires to extend the meeting more than one time, and also no subsequent meetings are booked during the multiple extending period of time, then the meeting owner of the ongoing meeting is allowed to do that. Alternatively, this process of extending resource bookings is iterative and returns to step S255 upon successfully extending the booking of a resource.

If no resource is found from step S280 for the next meeting for the initially booked meeting duration, processing proceeds to step S290 where the resource search module 310 searches an available resource for the ongoing meeting. In this exemplary embodiment, resource adjustment does not happen for the next meeting. Instead, module 310 tries to find a resource for the ongoing meeting that is available for the extended period of time (e.g., 15 minutes).

If a resource is found for the ongoing meeting for the extended period of time (i.e., “Yes” is chosen from step S290), processing proceeds to step S295 where resource booking module 315 books that resource for the extended period of time. Further, module 315 prompts the participants of the ongoing meeting to move to the new resource after the initially booked time for the current resource passes. In addition, calendar of the participants of the ongoing meeting get booked for 15 more minutes. Once the booked extending time passes, processing proceeds to step S310 where wrap-up module 320 wraps up the ongoing meeting. Alternatively, if the owner of the ongoing meeting desires to extend the meeting more than one time, and also no subsequent meetings are booked during the multiple extending period of time, then the meeting owner of the ongoing meeting is allowed to do that.

If a resource is not found for the ongoing meeting for the extended period of time (i.e., “No” is chosen from step S290), processing proceeds to step S310 where wrap-up module 320 wraps up the ongoing meeting, and the meeting owner is prompted with an appropriate message.

Now circling back to step S275, in this exemplary embodiment, if the flag at the global level is not “On”, that is, a “No” is chosen in step 275, then processing proceeds to step S300 where meeting status module 305 determines the default value of the global level flab (i.e., defaulted as “Off”, or defaulted as “Requires Approval”).

If “No” is chosen from step S300, the booking system is not allowed to change the meeting resource for the next meeting. Instead, processing proceeds back to step S290 where the resource search module 310 searches an available resource for the ongoing meeting. In this exemplary embodiment, resource adjustment does not happen for the next meeting. Module 310 tries to find a resource for the ongoing meeting that is available for the extended period of time (e.g., 15 minutes). Then from step S290, processing proceeds to different steps based on different situations.

If “Yes” is chosen from step S300, the booking system proposes a change of the resource to the meeting owner of the next meeting and changes the meeting resource only if the meeting owner approves the change. In this exemplary embodiment, processing proceeds to step S280 where resource search module 310 searches to find a resource available for the next meeting by considering the criteria requirements set by the next meeting owner.

If an available resource is found for the next meeting, processing proceeds to step S305, where meeting status module 305 requests the consent of the next meeting owner by asking if the room can be changed for the next meeting. If the next meeting owner agrees to make the resource change, then processing proceeds to step S285 where resource booking module 315 books that resource and informs the participants of the next meeting about change in the resource by, for example, prompting a message on their systems, or sending an email, or using an instant messenger service. In addition, if the digital notice boards are installed outside the meeting rooms and are connected with the booking system, the boards show a message indicating a change in the meeting room for the next meeting. After the available resource is booked for the next meeting, processing proceeds back to step S270 where module 315 books the room in which the ongoing meeting is for 15 more minutes for the ongoing meeting. Calendar of the participants of the ongoing meeting get booked for 15 more minutes for all the participants who have originally accepted the meeting request. Once the booked extending time passes, processing proceeds to step S310 where wrap-up module 320 wraps up the ongoing meeting. Alternatively, if the owner of the ongoing meeting desires to extend the meeting more than one time, and also no subsequent meetings are booked during the multiple extending period of time, then the meeting owner of the ongoing meeting is allowed to do that.

If the next meeting owner does not agree to make a change of the resource from step S305, then processing proceeds to step 290 where the resource search module 310 searches an available resource for the ongoing meeting. In this exemplary embodiment, resource adjustment does not happen for the next meeting. Module 310 tries to find a resource for the ongoing meeting that is available for the extended period of time (e.g., 15 minutes). Then from step S290, processing proceeds to different steps based on different situations.

Some embodiments of the present invention are directed to extending an in-progress meeting for durations longer than the exemplary 15 minutes discussed above. For example, a meeting owner may desire an extension of 1 hour. Where a meeting is extended for a relative long duration, it is likely that multiple next meetings will be affected. A decision will be taken in light of the various overlapping meeting requirements to, for example, change the room flag for each of the meetings and relocate each of the meetings to other appropriate resources. Some embodiments of the present invention determine appropriateness of a given resource by a set of predefined resource requirements for each scheduled meeting.

Some embodiments of the present invention may include one, or more, of the following features, characteristics and/or advantages: (i) resolves the meeting conflict with minimum user interaction; (ii) creates a win-win situation for both the teams involved in a meeting conflict; (iii) provides an executive preference over other non-executives in meeting conflict management; (iv) considers the resource requirement criteria set by the stakeholders before the room/resource adjustments; (v) considers the prior/real time consent of the stakeholders before the resource adjustments; (vi) considers any other rule set at a global level for this conflict management.

Some helpful definitions follow:

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

User/subscriber: includes, but is not necessarily limited to, the following: (i) a single individual human; (ii) an artificial intelligence entity with sufficient intelligence to act as a user or subscriber; and/or (iii) a group of related users or subscribers.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A method for managing meeting resource allocation, the method comprising:
determining a first consent level for a first meeting;
determining a first meeting resource criteria;
identifying a first set of meeting resources that meet the first meeting resource criteria;
reserving a first meeting resource from the first set of meeting resources; and
responsive to a change in the first meeting resource criteria, reserving a second meeting resource.

2. The method of claim 1, wherein the step of reserving a second meeting resource includes:
identifying a conflicted meeting resource;
determining a second consent level of the conflicted meeting resource;
responsive to the second consent level permitting the change in the first meeting resource criteria;
reserving the second meeting resource; and
determining a second reservation for the conflicted meeting resource.

3. The method of claim 2, wherein the step of permitting the change in the first meeting resource criteria includes:
specifying an extending duration for the first meeting; and
determining availability of the second meeting resource for the extending duration;
wherein the second meeting resource is the same as the first meeting resource.

4. The method of claim 3, wherein the step of specifying an extending duration for the first meeting is performed a certain amount of time prior to completion of the first meeting,
wherein the certain amount of time is programmable including one of the following: (i) a time specified by meeting owner of the first meeting; and (ii) a time defaulted by meeting owner of the first meeting.

5. The method of claim 2, wherein the second consent level includes giving organization executives preferences over non-executives.

6. The method of claim 2, wherein the step of determining a second reservation for the conflicted meeting resource includes:
determining availability of a third meeting resource based on the second consent level; and
reserving the third meeting resource to replace the conflicted meeting resource.

7. The method of claim 2, further comprising:
notifying participants of both the first meeting and the conflicted meeting by one of the following: (i) prompting a message on the participants' computer systems; (ii) sending an email to the participants; (iii) using an instant messenger service; and (iv) showing a message on a digital notice board.

8. The method of claim 1, wherein the step of reserving a first meeting resource from the first set of meeting resources includes: booking calendars of all participants of the first meeting.

9. The method of claim 1, wherein the first meeting resource criteria include: (i) room capacity; (ii) projector availability; and (iii) conference bridge.

10. The method of claim 1, wherein the first meeting resource criteria are subject to changes near the end of the meeting duration for the first meeting, the changes being based on more accurate parameters including the actual number of meeting participants.

11. The method of claim 1, further comprising:
identifying a conflicted meeting resource;
determining a conflicted meeting resource criteria;
identifying a second set of meeting resources that meet the conflicted meeting resource criteria;
determining a third meeting resource from the second set of meeting resources and the second meeting resource from the first set of meeting resources; and
reserving the third meeting resource.
